(19) United States
(12) Patent Application Publication
(10) Pub. No.: US 2026/0073355 A1
(43) Pub. Date: Mar. 12, 2026

(54) GENERATION OF TAILORED PRODUCT DESCRIPTION INFORMATION USING MACHINE LEARNING

(71) Applicant: Thinkhaus Idea Factory, LLC., Kings Mills, OH (US)

(72) Inventors: Kelly L. Smith, Kings Mills, OH (US); Meaghan Willis, Olive Branch, MS (US); Nick Willis, Olive Branch, MS (US); Jeremy Osborn, Olive Branch, MS (US)

(21) Appl. No.: 19/325,454

(22) Filed: Sep. 10, 2025

Related U.S. Application Data
(60) Provisional application No. 63/692,985, filed on Sep. 10, 2024.

(51) Int. Cl. G06Q 10/10; G06Q 30/018

(52) U.S. Cl. CPC G06Q 10/10; G06Q 30/018

(57) ABSTRACT

A method is provided for generating product description information for a product. The method includes receiving a request to generate the product description information, retrieving product data for the product, and determining user instructions indicated in the request. The method further includes retrieving one or more contextual datasets curated with information relevant to the product. The one or more contextual datasets include one or more of: search engine optimization data, brand standards data, industry or organization norms data, and target consumer preferences data. The method further includes generating the product description information by providing the product data, the one or more user instructions, and the one or more contextual datasets as inputs to a data model to cause the data model to output the product description information. The method further includes providing the product description information for display on a user interface of a device or application.

### RELATED APPLICATION

This application claims priority to U.S. Provisional Patent Application Ser. No. 63/692,985 filed Sep. 10, 2024, entitled “Tailored Product Description Generation Using Machine Learning,” the contents of which is hereby incorporated herein by reference, in its entirety.

### FIELD OF THE INVENTION

The present invention relates to systems and methods for automated content generation, and more particularly, to generating tailored product descriptions information for retail and e-commerce platforms using machine learning.

### BACKGROUND

The growth of e-commerce has transformed the retail landscape. Larger retailers, such as grocery stores, face the challenge of creating detailed and accurate product descriptions for thousands of products offered through online platforms. These descriptions typically include critical information such as the product name, ingredients, nutritional information, allergen warnings, usage instructions, and other pertinent details. Creating high quality product descriptions is essential for increasing a product's visibility on search engines and influencing consumer purchasing decisions.

Existing systems for generating product descriptions are not well-suited to handle the complexity and scale of modern product data ecosystems. Retailers often receive product data from numerous suppliers, with each supplier maintaining product information in different formats, schemas, and naming conventions. As a result, generating a consistent and accurate product description requires significant manual intervention to collect, clean, and standardize data from multiple sources. Further, these descriptions must comply with dynamic and evolving requirements, including regulatory standards, brand tone and style guides, and search engine optimization (SEO) guidelines.

Conventional solutions, such as rules-based templates or simple keyword-matching algorithms, are inadequate to solve this technical problem at scale. Conventional solutions are not capable of dynamically integrating heterogeneous datasets or applying real-time optimization strategies based on changing regulations, consumer preferences, and engagement metrics. Consequently, retailers and brand managers must rely on manual workflows which are inefficient, error-prone, and unscalable given the vast number of products in a typical retailer's inventory.

This technical limitation often leads to incomplete, inaccurate, or generic product descriptions. The use of a generic product description can reduce product visibility in search engine results and erode consumer trust. Inconsistent or missing product information can cause customer frustration and, in the case of food or health products, create safety risks.

It is an object of the invention to provide a technological solution to these challenges by introducing a machine learning-based platform capable of ingesting heterogeneous product data, standardizing the data into a unified schema, dynamically integrating contextual datasets, and generating product description information that is compliant, optimized, and brand-consistent.

### SUMMARY

In an aspect of the invention, a method for generating product description information for a product is provided. The method includes receiving, by a computing device and as an input provided by a user, a request to generate the product description information for the product. The method further includes retrieving, by the computing device and by using a product identifier included in the request, product data for the product. The product data includes a corresponding product identifier and data describing one or more attributes of the product. The method further includes determining, by the computing device, one or more user instructions indicated in the request. The method further includes retrieving, by the computing device, one or more contextual datasets curated with information relevant to the product. The one or more contextual datasets include at least one of: search engine optimization (SEO) data, brand standards data, industry or organization norms data, and target consumer preferences data. The method further includes generating, by the computing device, the product description information for the product by providing the product data, the one or more user instructions, and the one or more contextual datasets as inputs to a data model to cause the data model to output the product description information for the product. The data model is trained using machine learning to generate the product description information in a manner that complies with product description parameters derived from the one or more contextual datasets. The method further includes providing, by the computing device, the product description information for display on a user interface of a device or application.

In an embodiment of the invention, the method further includes obtaining heterogeneous product data for the product from a plurality of disparate data sources prior to receiving the request. The heterogeneous product data is standardized by mapping product data values to a schema and normalizing the product data values into a uniform machine-readable format. The standardized product data is aggregated to create the product data. The product data that has been standardized and aggregated is stored in a data repository in a manner that is retrievable for use in generating the product description information.

In another embodiment of the invention, the method further includes retrieving another contextual dataset that includes regulatory rules data that identifies at least one law or regulation relating to the product description information. Generating the product description information may include providing the regulatory rules data as an input to the data model such that the data model generates the product description information in a manner that is compliant with the at least one law or regulation.

In another embodiment of the invention, the method further includes providing, while the user is inputting a prompt as part of the request, feedback on compliance of the prompt with the product description parameters derived from at least one of the brand standards data, the SEO data, and the regulatory rules data. The feedback is displayed on the user interface in a manner that emphasizes non-compliant words or phrases.

In another embodiment of the invention, the one or more contextual datasets include historical sales data and consumer preferences data. The data model is configured to apply weighted values to product description terms based on a frequency of consumer engagement with, or purchase of, the product.

In another embodiment of the invention, the product description information includes a narrative description of the product and a set of feature bullet points. Each feature bullet point is generated in a format optimized for a respective e-commerce platform or product listing channel.

In another embodiment of the invention, the method further includes providing the product description information to a print system configured to generate a physical label for the product.

In another aspect of the invention, a computing device for generating product description information for a product is provided. The computing device includes a memory storing instructions and a processor communicatively coupled to the memory. The processor is configured to receive, as an input provided by a user, a request to generate the product description information for the product. The processor is also configured to retrieve product data for the product using a product identifier included in the request. The product data includes a corresponding product identifier and data describing one or more attributes of the product. The processor is further configured to determine one or more user instructions indicated in the request. The processor is further configured to retrieve one or more contextual datasets curated with information relevant to the product. The one or more contextual datasets include one or more of: SEO data, brand standards data, industry or organization norms data, and target consumer preferences data. The processor is further configured to generate the product description information for the product by providing the product data, the one or more user instructions, and the one or more contextual datasets as inputs to a data model to cause the data model to output the product description information for the product. The data model is trained using machine learning to generate the product description information in a manner that complies with product description parameters derived from the one or more contextual datasets. The processor is further configured to provide the product description information for display on a user interface of a device or application.

In an embodiment of the invention, the one or more contextual datasets are periodically updated to reflect changes to the SEO criteria, brand standards, or industry or organization norms.

In another embodiment of the invention, the processor is configured to retrieve another contextual dataset that includes regulatory rules data identifying at least one law or regulation relating to the product description information. The processor, when generating the product description information, is configured to provide the regulatory rules data as an input to the data model such that the data model generates the product description information in a manner that is compliant with the at least one law or regulation.

In another embodiment of the invention, the processor is configured, prior to receiving the request, to obtain heterogeneous product data for the product from a plurality of disparate data sources. In this embodiment, the processor is further configured to standardize the heterogeneous product data by mapping product data values to a schema and normalizing the product data values into a uniform machine-readable format. In this embodiment, the processor is further configured to aggregate standardized product data to create the product data. In this embodiment, the processor is further configured to store the product data in a data repository in a manner that is retrievable for use in generating the product description information.

In another embodiment of the invention, the processor is further configured to generate the product description information in a plurality of formats, including a long-form description, a short-form summary, and an SEO-optimized title.

In another embodiment of the invention, the processor is configured, when providing the product description information for display on the user interface, to cause the user interface to display a split view showing a first section with the product description information prepared in a narrative description format and a second section with the product description information prepared in a bullet point format.

In another embodiment of the invention, the processor is further configured to provide, for display on the user interface, feedback of non-compliant text while the user is inputting a prompt as part of the request.

In another aspect of the invention, a non-transitory computer-readable medium stores instructions that include one or more instructions that, when executed by a processor of a computing device, cause the processor to receive, as an input provided by a user, a request to generate the product description information for the product. The instructions also cause the processor to retrieve product data for the product using a product identifier included in the request, where the product data includes a corresponding product identifier and data describing one or more attributes of the product. The instructions further cause the processor to determine one or more user instructions indicated in the request. The instructions also cause the processor to retrieve one or more contextual datasets curated with information relevant to the product, where the one or more contextual datasets include one or more of: SEO data, brand standards data, industry or organization norms data, and target consumer preferences data. The instructions further cause the processor to generate the product description information for the product by providing the product data, the one or more user instructions, and the one or more contextual datasets as inputs to a data model to cause the data model to output the product description information for the product. The data model is trained using machine learning to generate the product description information in a manner that complies with product description parameters derived from the one or more contextual datasets. The instructions also cause the processor to provide the product description information for display on a user interface of a device or application.

In an embodiment of the invention, the instructions that cause the processor to generate the product description information further cause the processor to generate a set of feature bullet points by ranking product attributes according to a set of relevance scores derived from consumer engagement metrics.

In another embodiment of the invention, the instructions that cause the processor to retrieve the one or more contextual datasets further cause the processor to retrieve category-specific norms that define a preferred tone, attribute order, or feature emphasis for a respective product category.

In another embodiment of the invention, the instructions, when executed by the processor, further cause the processor to store the product description information that has been generated to a data structure in a format suitable for downstream editing or quality assurance review.

In another embodiment of the invention, the instructions that cause the processor to provide the product description information for display further cause the processor to provide visual feedback on the user interface in a manner that emphasizes a regulatory inconsistency or a brand guideline violation.

In another embodiment of the invention, the instructions, when executed by the processor, further cause the processor to retrieve another contextual dataset that includes regulatory rules data that identifies at least one law or regulation relating to the product description information. The instructions that cause the processor to generate the product description information further cause the processor to provide the regulatory rules data as an input to the data model such that the data model generates the product description information in a manner that is compliant with the at least one law or regulation.

### BRIEF DESCRIPTION OF THE DRAWINGS

FIGS. 1A-1D are diagrams of am example process for using machine learning to train a data model to generate product description information.

FIGS. 2A-2E are diagrams of an example process for using the trained data model to generate product description information for a product.

FIG. 3 is a diagram of an example environment in which systems and/or methods described herein may be implemented.

FIG. 4 is a diagram of example components of one or more devices of FIG. 3.

### DETAILED DESCRIPTION

The following detailed description of example embodiments refers to the accompanying drawings. The same reference numbers in different drawings may identify the same or similar elements.

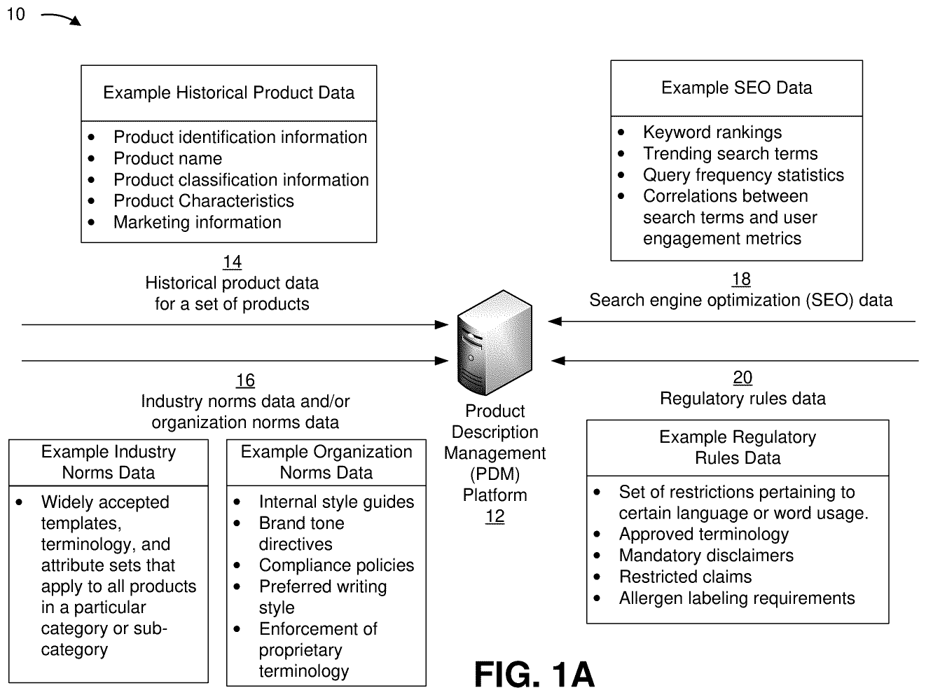

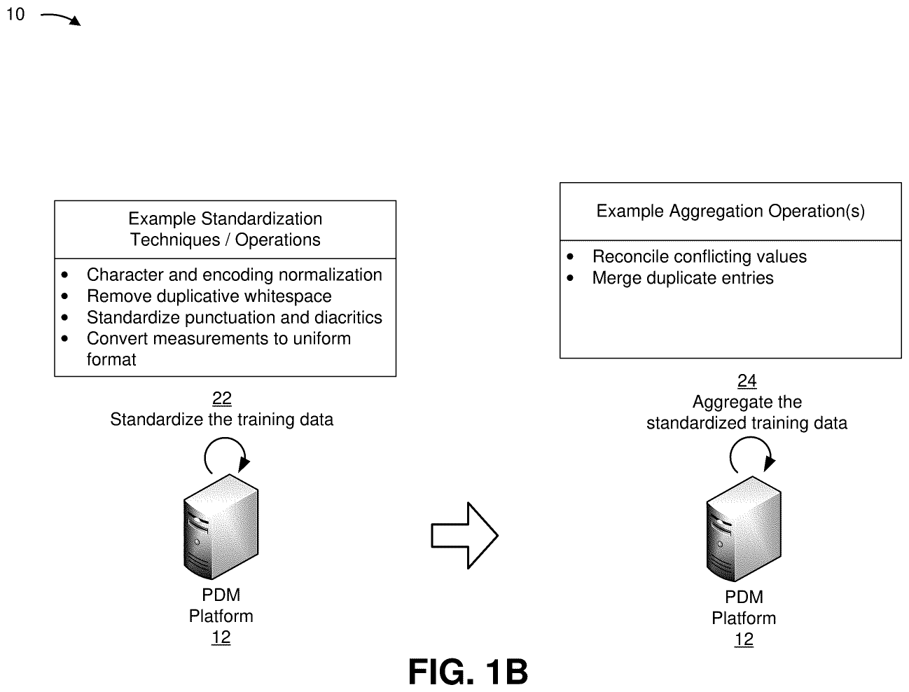

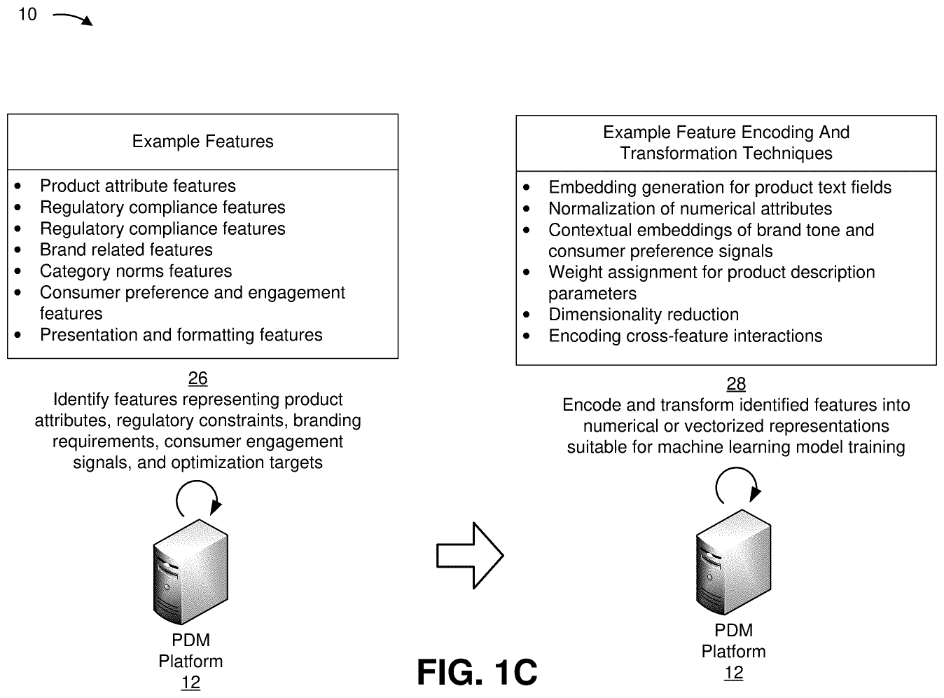

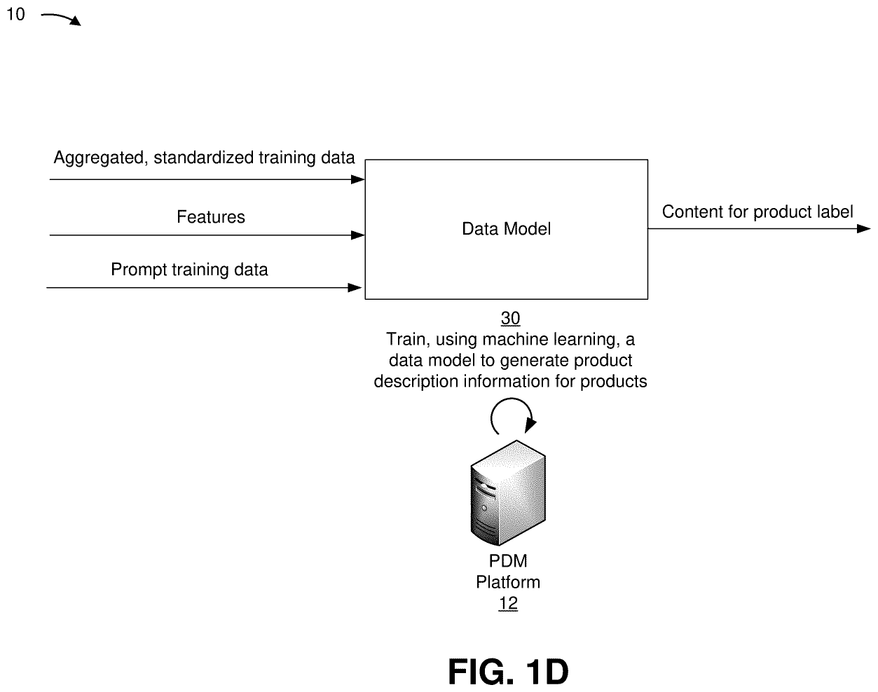

FIGS. 1A-1D are diagrams of an example process 10 for using machine learning to generate product description information for products. For example, a product description management (PDM) platform 12 may use a data model trained using machine learning to generate product description information for a product. The term “product description information” refers to content that describes a product and associated attributes in a structured, machine-readable format suitable for automated rendering, display, and/or downstream processing. The product description information may include, for example, a narrative product description, a set of feature bullet points, branding information, regulatory compliance statements, product metadata, or other descriptive elements relevant to e-commerce listings, retail packaging, or point-of-sale systems. In some embodiments, the product description information may be generated in multiple formats, such as a long-form marketing description, an SEO-optimized title, or a condensed summary for small-screen displays. The product description information may be structured and stored in a manner that enables automated integration with enterprise systems, printing workflows for physical labels, and content management platforms. The information may be dynamically generated based on contextual datasets, such as SEO ranking data, regulatory rule databases, brand guidelines, and consumer engagement metrics. This ensures that the product description information remains compliant, brand-consistent, and optimized over time.

In some embodiments, such as that shown in FIGS. 1A-1D, the data model may be trained by the PDM platform 12. In other embodiments, another device or combination of devices may be used to train the data model. In this embodiment, the trained data model may be provided to or made accessible to the PDM platform 12.

As shown in FIG. 1A, the PDM platform 12 may receive training data. The training data may be used to train a data model using machine learning to generate product label files. The PDM platform 12 may receive the training data over a network, such as the Internet, an application programming interface (API), a secure file transfer protocol (SFTP), or another type of communication interface. The training data may be received from a variety of disparate data sources, including one or more product owner databases, one or more retailer databases, one or more regulatory content databases, one or more third party product information databases, and/or one or more category norms databases. The data received from the variety of disparate data sources may be in a structured format, a semi-structured format (e.g., JSON, XML, CSV, a spreadsheet, etc.), or in some cases, an unstructured format.

A product owner database may, for example, be a manufacturer-maintained product information management (PIM) system. A retailer database may, for example, be an inventory catalog with pricing records. A regulatory content database may, for example, be Food and Drug Administration (FDA) labeling database, a GS1 standards database that maintains structured data and identifiers such as a Global Trade Item Numbers (GTINs), universal product codes (UPCs), and barcode specifications for supply chain interoperability. A third-party PIM database may, for example, be a syndicated content management platform (e.g., Syndigo) or a public product data aggregator from which UPC-linked product images, descriptions, and attributes can be obtained.

A category norms database may, for example, be a database that defines standardized terminology, style guidelines, and content expectations for specific product categories. Such a repository may include structured templates that identify which product attributes are typically emphasized in a product label (e.g., crust style, cheese type, and toppings for frozen pizzas), which descriptors or terms are discouraged (e.g., the term “luxury” for value-brand products), and tone or formatting preferences (e.g., bullet-point feature lists for electronics, narrative descriptions for beverages, etc.). Category norms databases may also include historical examples of high-performing product descriptions, curated taxonomies, or machine-readable ontologies that describe relationships between product attributes.

The training data may include historical product data, historical norms data, historical search engine optimization (SEO) data, historical regulatory rules data, and/or the like. In some embodiments, the training data may include a full product catalog and corresponding metadata from a retailer (e.g., Kroger, etc.). As shown by reference number 14, the PDM platform 12 may receive historical product data for a set of products. The historical product data represents a comprehensive view of all SKU-level attributes as maintained by manufacturers, retailers, and syndicated content providers. The historical product data for each of a variety of products may include product identification information, a product name, hierarchical classification information, key characteristics, a marketing description, and/or the like.

The product identification information may, for example, include an SKU code, a UPC code, a GTIN identifier, and/or the like. The product name may, for example, identify the name of a product. The hierarchical classification information may include a product category, one or more sub-categories, and/or a product placement hierarchy. For example, the category may be beverages, the sub-category may be water, and the water may be further categorized as being Sparkling Water and/or Citrus-Flavored. Product placement hierarchy refers to a position of the product within a store, warehouse, or online listing system (e.g., Aisle 6, Beverage Section, Eye-level Shelf, etc.).

The key characteristics may include characteristics that distinguish a product within its category, such as a flavor profile, a material composition, a functional feature, or a unique selling point. For example, a sparkling water product may have a natural lime essence, zero calories, and no artificial sweeteners. To provide another example, a wearable fitness device may specify water resistance, battery life, and compatibility with certain smartphone operating systems.

The marketing description may include a concise, consumer-facing narrative or structured string of text intended for product listings, packaging, or promotional materials. The marketing description summarizes key product attributes in a manner optimized for consumer engagement rather than regulatory completeness. For example, a marketing description for a sparkling water product may read: “Crisp, carbonated water infused with a hint of lime, packaged in recyclable aluminum cans.” Similarly, a marketing description for an apparel item may state: “Men's athletic hoodie featuring a moisture-wicking fabric blend, reinforced seams, and an adjustable drawstring hood.”

Additionally, or alternatively, the historical product data may include product usage data, technical specifications data, pricing data, availability data, brand data, consumer review or ratings data, customization data, environmental data, images and media data, and/or the like. Product usage data may describe recommended or intended uses for the product, such as “Best served chilled” or “For outdoor use only,” as well as safety instructions or warnings.

Technical specifications data may include quantitative details, such as dimensions, weight, voltage requirements, connectivity standards (e.g., Bluetooth 5.0), packaging tolerances, and/or the like. Pricing data may include base pricing, historical promotional pricing, and tiered discount information. Availability data may indicate current stock levels, expected restocking dates, or geographic availability (e.g., “Available only in Midwest region stores”). Brand data may provide details about the manufacturer or distributor, including brand positioning (e.g., value-tier, premium-tier) and origin details. Consumer review or ratings data may aggregate customer feedback, such as star ratings, review counts, and summarized sentiment analysis. Customization data may identify configurable features, such as size, color, or engraving options. Environmental data may specify sustainability certifications, recycled content percentages, or carbon-neutral production claims. Images and media data may include high-resolution product imagery, lifestyle photographs, packaging visuals, and multimedia elements.

Additionally, or alternatively, the historical product data may include packaging data, marketing data, and/or sales data. The packaging data may include detailed information describing the physical packaging and presentation of a product. For example, packaging data may specify the type of packaging (e.g., plastic bottle, aluminum can, corrugated box), physical dimensions (e.g., height, width, depth, and volume), net and gross weight, and the materials used in both primary and secondary packaging. The packaging data may further include visual or structural design elements, such as color schemes, branding placement, or custom layouts, as well as details about the package contents, such as the number of units per package or inclusion of accessories. In some embodiments, the packaging data may also identify assembly or setup requirements (e.g., “attach sprayer to bottle”), shipping and palletization specifications (e.g., “48 cases per pallet”), and environmental considerations, including recyclability ratings, compostable materials, or eco-label certifications. Packaging data may also include barcode and labeling specifications, such as UPC placement, QR codes, and compliance with GS1 labeling standards.

The marketing data may include content and metadata designed to promote consumer engagement and brand recognition. For example, the marketing data may incorporate product taglines, promotional slogans, and other persuasive messaging intended to highlight unique product benefits or brand values. Marketing data may also include campaign-specific creative briefs, branding style guides, and brand voice directives (e.g., “casual and approachable tone” or “luxury and aspirational branding”), as well as historical advertising materials such as banners, videos, and digital assets. In some embodiments, marketing data may specify channel-specific messaging, including variations for e-commerce listings, in-store signage, or social media campaigns.

The sales data may include commercial performance information for respective products, capturing both historical and real-time transactional metrics. For example, sales data may include product identifiers (e.g., SKU numbers, UPCs), product summary data, and structured records showing sales volume, revenue, and geographic distribution over defined time periods. Sales data may further include store-level or warehouse-level performance data, channel-specific sales breakdowns (e.g., in-store vs. online), inventory velocity trends, and seasonal demand fluctuations. In some embodiments, the sales data may include promotional effectiveness metrics, such as sales lift during a campaign, as well as predictive analytics derived from historical sales patterns, which may be used to inform product positioning and description optimization.

As shown by reference number 16, the PDM platform 12 may receive industry norms data and organization norms data for product descriptions. Industry norms data may be sourced from trade association style guides, publicly available category standards, and curated datasets of high-performing listings from across the industry. Industry norms data may define widely accepted templates, terminology, and attribute sets that apply to all products within a particular category or subcategory, regardless of brand or retailer. For example, for frozen pizza products, industry norms data may specify that a product description should identify the crust type (e.g., thin crust, deep dish, etc.), sauce base (e.g., marinara, white sauce, etc.), primary toppings (e.g., pepperoni, vegetables, etc.), and cooking method (e.g., stone-fired, etc.). In another example, industry norms data for electronics may emphasize specifications such as processor speed, storage capacity, and battery life.

The organization norms data may encode retailer-specific, distributor-specific, or brand-specific guidelines for product descriptions. The organization norms data may be drawn from internal style guides, brand tone directives, and retailer-specific compliance policies. Organization norms data may define a preferred writing style (e.g., “premium” or “budget-friendly” positioning), enforce the use of proprietary terminology (e.g., “Organic Promise™”), restrict or prohibit certain marketing or regulatory-sensitive claims (e.g., “All natural”, “Clinically proven”, etc.), and specify formatting conventions for descriptive text and promotional messaging (e.g., separating factual product specifications from time-limited offers or advertising slogans). For example, a retailer may require that all apparel product descriptions include sizing details in the title, while a brand may mandate disclaimers about limited-edition product availability. In some embodiments, organization norms data may include historical examples of successful marketing content for a given retailer or brand which can be used to fine-tune model output for consistency and brand alignment.

As shown by reference number 18, the PDM platform 12 may receive search engine optimization (SEO) data to improve the visibility and discoverability of product content in online platforms and search engines. SEO data may include keyword rankings, trending search terms, and query frequency statistics for products and product categories, as well as correlations between search terms and user engagement metrics (e.g., cart-add frequency, click-through rates, purchase conversions, etc.). For example, within the product group “snacks,” SEO data may indicate that “chips” yielded 11,639 cart-adds over a given reporting period, “honey roasted peanuts” yielded 13 cart-adds, and “munchies” yielded 15 cart-adds. In some embodiments, SEO data may also include metadata from search engine crawlers, paid advertising performance statistics, and retailer-specific query logs, enabling the generation of descriptions optimized for both general search engines and proprietary e-commerce platforms.

As shown by reference number 20, the PDM platform 12 may receive regulatory rules data defining restrictions and requirements for product labels and descriptions. Regulatory rules data may be obtained from government databases (e.g., FDA, USDA, EPA), GS1 compliance databases, or retailer-specific compliance rulebooks. The regulatory rules data may specify approved terminology, mandatory disclaimers, restricted claims, allergen labeling requirements, or regional language regulations. For example, regulatory rules data may indicate that a frozen fruit bar made from fruit juice concentrate cannot be described as “made with real fruit,” or that a dietary supplement must include a disclaimer regarding an FDA evaluation. The regulatory rules data may also include allergen labeling rules (e.g., “Contains peanuts”), ingredient order requirements, organic certification criteria, and sustainability certifications. By integrating regulatory rules data, the PDM platform 12 ensures that generated product label file includes content that adheres to national, global and retailer-specific standards.

In this way, the PDM platform 12 receives, from disparate data sources, training data that can be used to train a data model capable of generating product label files that are complete, optimized, and compliant with any applicable regulatory laws and regulations.

As shown in FIG. 1B, and by reference number 22, the PDM platform 12 may standardize the training data. For example, the PDM platform 12 may convert training data into a unified schema. In some embodiments, the PDM platform 12 may first perform character and encoding normalization. For example, the PDM platform 12 may convert training data to a Unicode Transformation Format (UTF)-8, may remove duplicate whitespace, and may standardize punctuation and diacritics (e.g., converting “fl. oz.” to “fl oz” or “café” to “cafe”), and may convert units of measurement to a uniform format.

In some embodiments, the PDM platform 12 may parse the title to separate the product name from any embedded size or container details. For example, “Kroger® Sparkling Water Lime 12 fl oz Can (12-Pack)” may be split into a long title, a short title excluding size, and a customer facing size field with “12×12 fl oz”. Brand and trademark references may be standardized to reflect proper placement of symbols and registry conventions (e.g., mapping “KROG” or “Kroger Co.” to “Kroger”) and ingredient lists may be tokenized, cleaned of redundant parentheticals, and preserved as structured metadata (e.g., “Ingredients: Water, Sugar (Cane Sugar), Natural Flavors” is stored as a normalized list with secondary annotations). Controlled vocabularies may be applied to unify synonymous descriptors, such as mapping “0 cal” to “zero calories” or aligning “non-dairy” and “dairy-free” based on retailer preference.

Once normalized, and as is shown by reference number 24, the PDM platform 12 may aggregate the standardized training data to create a unified product-level record for each unique item. In this aggregation step, the PDM platform 12 may reconcile conflicting values, merge duplicate entries, and ensure that each SKU is represented by a single record. Entity resolution may be performed using unique identifiers, such as UPCs, GTINs, or retailer-specific SKU codes as primary keys. In cases where multiple conflicting values exist (e.g., brand variations or packaging dimension discrepancies), deterministic rules, weighted confidence scoring, or source priority hierarchies may be used to select a preferred value. The aggregated dataset may be stored in a structured, machine-readable data store, such as a relational or document database, with discrete fields for identifiers, product titles, classification hierarchies, product characteristics, regulatory information, marketing messages, SEO keywords, historical sales performance metrics, and/or any other type of training data described in connection with FIG. 1A.

In this way, the PDM platform 12 transforms raw, inconsistent inputs from multiple disparate systems (e.g., retailer databases, manufacturer-maintained PIM platforms, syndicated content repositories, regulatory databases, etc.) into a unified dataset.

As shown in FIG. 1C, and by reference number 26, the PDM platform 12 may identify features representing attributes, constraints, and optimization signals relevant to product labeling. For example, the PDM platform 12 may analyze the aggregated and standardized training data to identify a set of machine-readable features that are predictive of specific output elements in the generated label file. These features may include, but are not limited to: product-specific attribute features, regulatory compliance features, brand and organizational directive features, category norms features, consumer preference and engagement features, presentation and formatting features, and/or the like.

Product-specific attribute features represent factual, SKU-level information about a product. These features may include identifiers, product hierarchy classifications, ingredient listings, package dimensions, net quantity, SKU metadata, and/or the like. Each of these features maps directly to core content elements in the label file, such as the product title, net quantity declaration, ingredient statement, product identifiers (e.g., UPC or GTIN), and associated product imagery references. Because these attributes are factual and SKU-specific, they are encoded as immutable values (e.g., as part of a requirements specification), ensuring consistency across all generated outputs.

Regulatory compliance features capture statutory or standards-based requirements from governing bodies (e.g., FDA, FTC, EFSA) and global supply chain standards organizations (e.g., GS1). These features may represent allergen disclosures, geographic origin statements, required order of ingredients, nutritional label formatting requirements, barcode placement, and specific wording constraints (e.g., “juice from concentrate” cannot be described as “made with real fruit”). Each compliance feature is mapped to mandatory label elements, such as bolded allergen warnings, formatted nutrition fact tables, or mandatory disclaimer blocks. The PDM platform 12 may implement these compliance features as binary or categorical flags, ensuring that these elements are always included, correctly formatted, and legally compliant.

Brand and organizational directive features encode retailer- or brand-specific policies for tone, structure, and branding elements. These may include voice and tone vectors (e.g., “premium,” “value,” “family-friendly”), formatting rules for capitalization or punctuation, internal SKU naming conventions, and approved use of proprietary branding terms or logos. These features influence stylistic and branding elements of the label, such as copy tone, typography guidelines, and inclusion of trademarks or proprietary marks. For example, a “premium” brand tier feature may increase emphasis on sensory language (“rich aroma,” “artisan-crafted”) and enforce logo placement, while a “value” brand tier feature may emphasize pricing and pack size.

Category norm features represent expected descriptive elements for products within a given category. These may be derived from historical data, industry style guides, or curated templates. Examples include emphasizing crust type, toppings, and preparation style for pizzas; flavor and carbonation type for beverages; and SPF, fragrance, or dermatologist-testing claims for personal care products. Each feature drives the inclusion and ordering of category-specific attributes in the label, ensuring that the generated label aligns with consumer expectations and industry standards.

Consumer preference features are derived from behavioral data, such as search term frequency, purchase history, review sentiment, click-through rate, and keyword-to-purchase conversion metrics. These features may be numerical weights or ranking values that guide the model to prioritize descriptors and attributes that resonate with consumers. For example, a highly weighted keyword may be positioned early in a product title, while review sentiment analysis may influence the emphasis of benefits over technical specifications. These features ensure that copywriting elements in the label are optimized for engagement and discoverability.

Presentation and formatting features define the visual and structural aspects of the product label. These may include barcode placement coordinates, spacing and alignment rules for allergen sections, typography scaling, and machine-readable element integration (e.g., QR codes, GS1-compliant barcodes). These features are mapped to layout specifications in the label file, ensuring that generated files are printer-ready and compliant with packaging standards.

Together, these features form a requirements specification that consolidates both factual product data and prescriptive label-generation rules into a single, machine-readable artifact. The requirements specification provides a deterministic mapping between each identified feature and a corresponding label output element. This feature-to-output mapping ensures that each generated label file is simultaneously compliant, stylistically consistent, and optimized for consumer engagement, while reducing manual intervention and audit overhead.

In some embodiments, features may be generated by a subject matter expert and provided to the PDM platform 12. In some embodiments, the PDM platform 12 may identify the features using one or more feature identification techniques.

As shown by reference number 28, the PDM platform 12 may perform feature encoding and transformation to convert the identified features into structured, machine-readable representations suitable for machine learning model training. This process may include representing categorical values (e.g., brand tier, product category, certification type) using one-hot or multi-hot encoding, scaling numerical values (e.g., package weight, volume, sales rank) into normalized ranges, and encoding binary flags for regulatory triggers (e.g., allergen presence, organic certification). Textual features, such as ingredient lists, product titles, and SEO keyword sets, may be tokenized and represented as embeddings or TF-IDF vectors. Constraint information, such as mandatory disclosures or prohibited claims, may be organized into constraint matrices or attention masks that enforce compliance during training and inference.

In some embodiments, the platform may enrich encoded features with derived weights that reflect historical engagement data, conversion metrics, or ranking performance, enabling the model to prioritize consumer-preferred descriptors. The resulting feature representation is a unified input vector or structured graph that links each product to its compliance rules, branding directives, and optimization signals, providing the data model with a comprehensive context for generating compliant and high-quality label files.

As shown in FIG. 1D, and by reference number 30, the PDM platform 12 may train a data model using machine learning to generate product labels. For example, the PDM platform 12 may train the data model using the selected features and one or more machine learning techniques. The one or more machine learning techniques may include classification-driven training technique, a logistical regression-based training technique, a Naïve Bayesian classifier technique, a support vector machine (SVM) technique, a neural network, and/or the like. The data model may be trained to classify product data and related data, and to generate product labels for products in a manner that is accurate, compliant, stylistically consistent, and optimized for retail and e-commerce environments.

In some embodiments, the data model may be a neural network, such as a transformer-based language model, that is first initialized or pretrained on a broad corpus of publicly available product descriptions, packaging information, and labeling guidelines. The pretrained model may then be fine-tuned using curated training data generated by the PDM platform 12, where each example includes a structured requirements specification, product-level attributes, and a ground truth label file. This fine-tuning step enables the data model to learn correlations between specific product features, regulatory rules, brand directives, and desired label outputs.

During training, constraint matrices and attention masks derived from regulatory and organizational rules may be applied to guide model predictions, ensuring that generated outputs meet compliance requirements. Optimization signals, such as keyword weights, sales performance metrics, and consumer sentiment scores, may be incorporated to bias the model toward producing descriptions that improve consumer engagement and search discoverability. The resulting trained model is capable of conditioning label generation on structured context, enabling it to produce product labels that are accurate, compliant, stylistically consistent, and optimized for retail and e-commerce environments.

In this way, the PDM platform 12 trains a data model to use machine learning to generate product descriptions that are tailored to branding strategies, organizational/industry preferences, and/or consumer preferences. Furthermore, the PDM platform 12 trains the data model to use machine learning to generate product descriptions in a way that optimizes the searchability of respective product descriptions in search engines and generates product descriptions that are compliant with any applicable regulatory rules.

As indicated above, FIGS. 1A-1D are provided merely as an example. Other examples may differ from what is described with regard to FIGS. 1A-ID. For example, there may be additional devices and/or networks, fewer devices and/or networks, different devices and/or networks, or differently arranged devices and/or networks than those shown in FIGS. 1A-1D. Furthermore, two or more devices shown in FIGS. 1A-1D may be implemented within a single device, or a single device shown in FIGS. 1A-1D may be implemented as multiple and/or distributed devices. Additionally, or alternatively, a set of devices (e.g., one or more devices) of example process 10 may perform one or more functions described as being performed by another set of devices of example process 10.

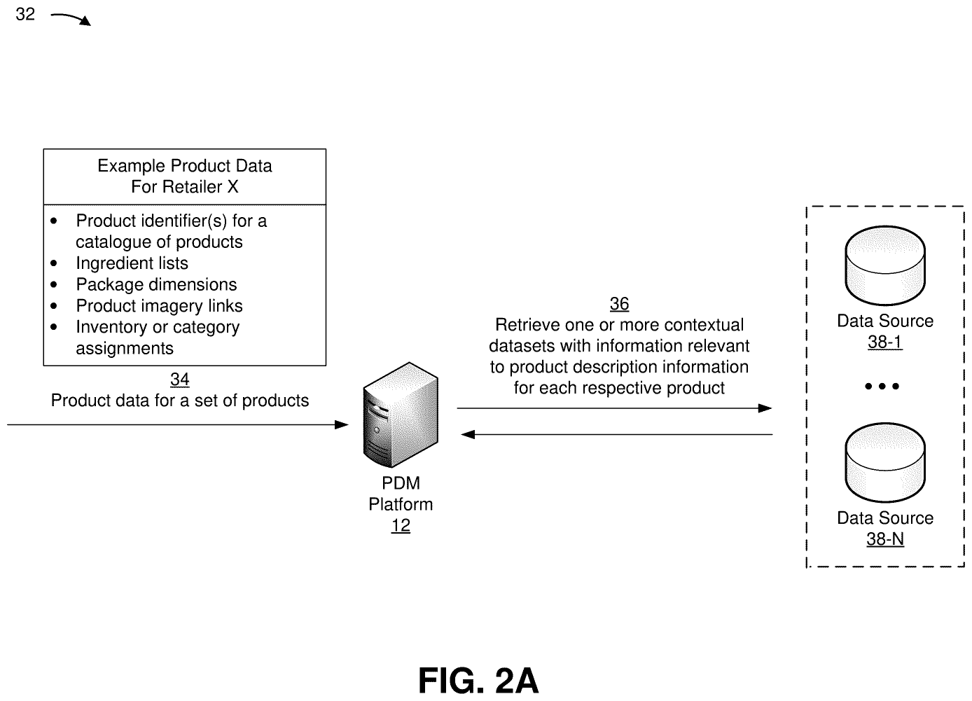

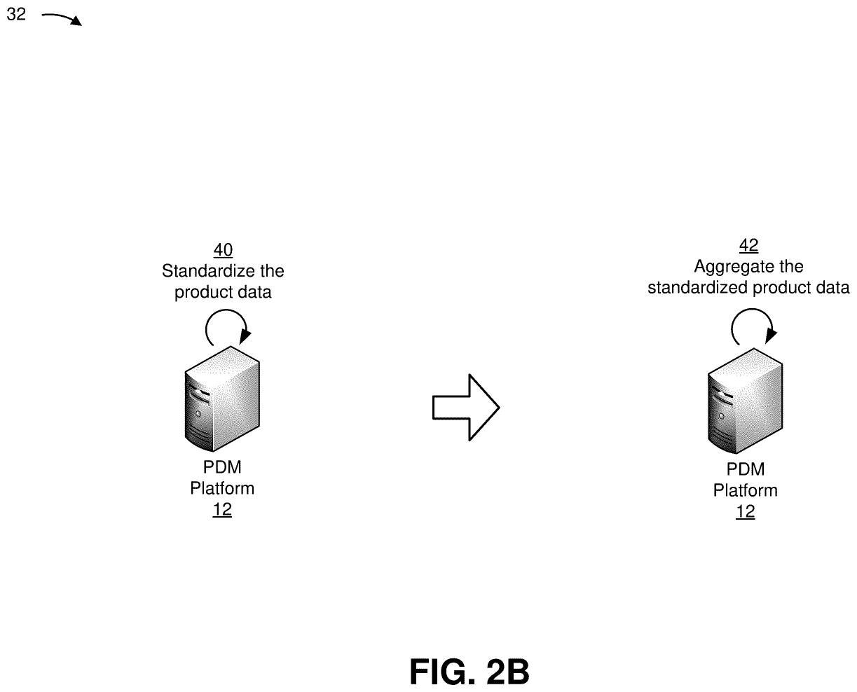

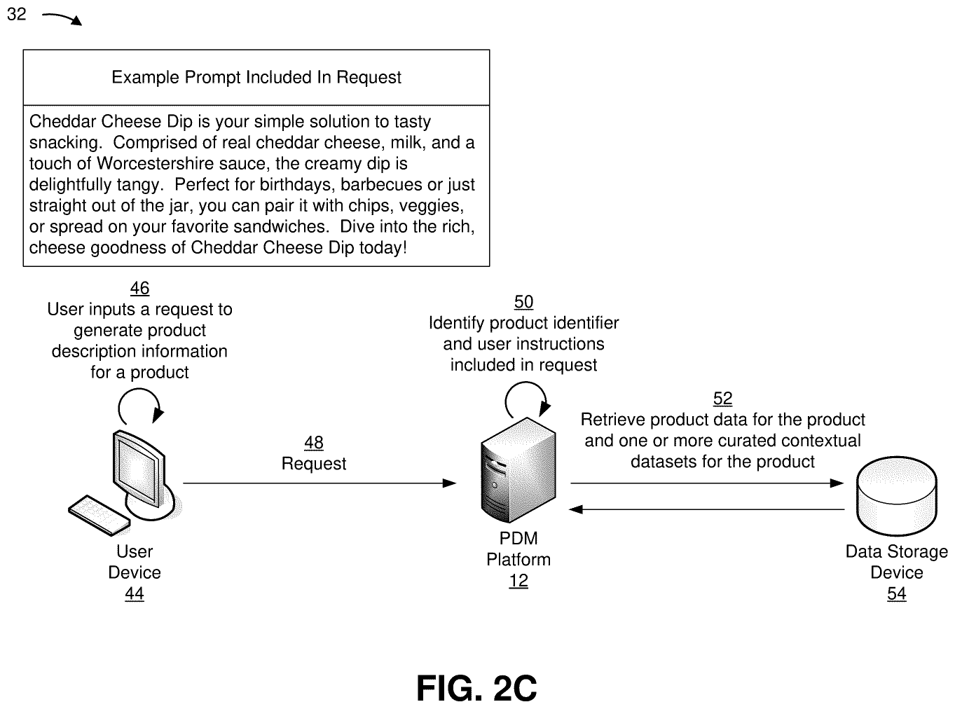

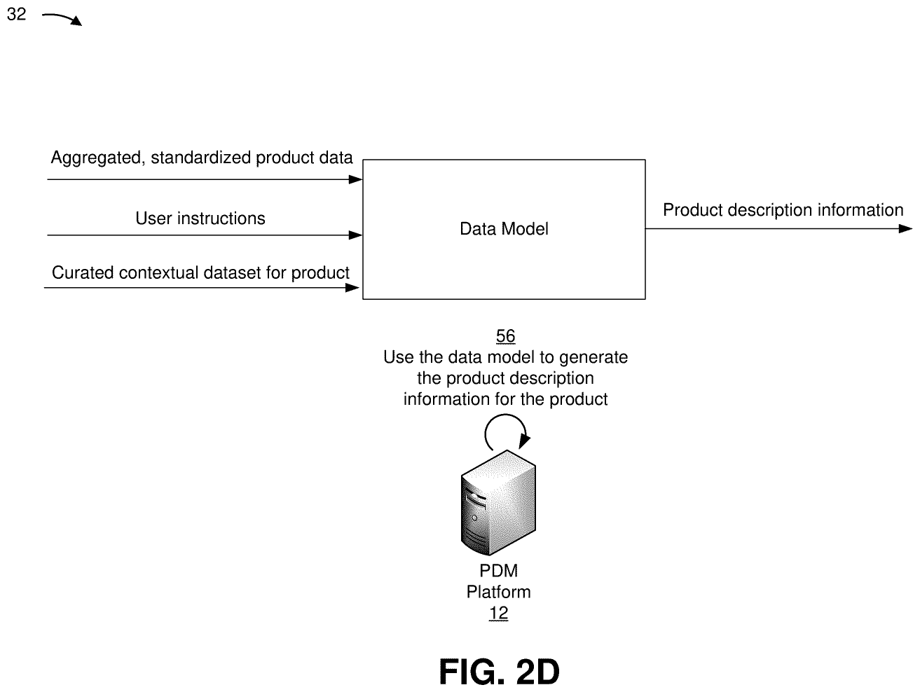

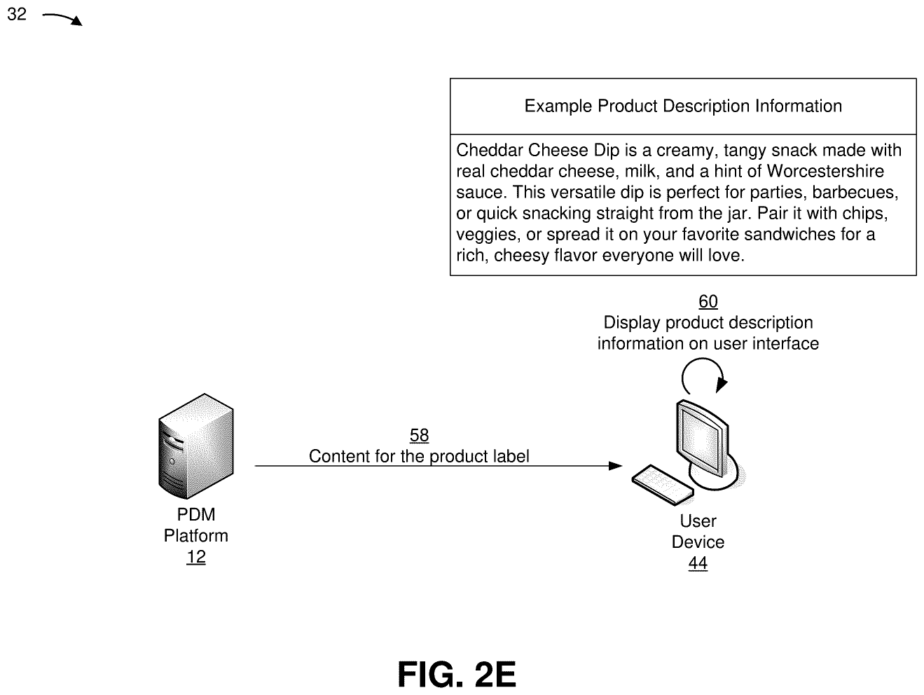

FIGS. 2A-2D are diagrams of an example process 32 for using the trained data model to generate product description information for a product. As shown in FIG. 2A, and by reference number 34, the PDM platform 12 may receive product data for a set of products. For example, an organization such as a retailer may want to use the PDM platform 12 to generate product description information for one or more products and may provide the PDM platform 12 with product data for the products. The product data may, for example, be for a full product line or full catalogue of products.

The product data may include all SKU-level attributes necessary to support label generation, such as product identifiers (e.g., a UPC identifier, etc.), an ingredient list, package dimensions, a product imagery link, and inventory or category assignments. In some embodiments, the PDM platform 12 may receive the product data directly from a manufacturer or retailer's product information management (PIM) system, an internal catalog database, or a syndicated content provider. The received product data may include raw or unformatted records that vary in field naming, file type, and data granularity depending on the source. For example, a user, such as an employee of a retail grocery store, may need product descriptions created for a complete inventor of products and may provide product data for those products to the PDM platform 12.

As shown by reference number 36, the PDM platform 12 may interact with one or more data storage devices 38 (shown as Data Source 38-1, . . . , Data Source 38-N) to retrieve contextual datasets with information relevant to product description information for each respective product. The contextual datasets are curated (see, e.g., FIGS. 1B and 1C) and periodically updated during or after training. The contextual datasets are used at inference time to ensure the product description information reflects current compliance requirements, branding standards, and optimization strategies, even as these evolve over time.

As shown in FIG. 2B, and by reference number 40, the PDM platform 12 may standardize the product data. For example, the PDM platform 12 may enforce a canonical schema, validate and normalize each product attribute, and apply standardized field mappings. In some embodiments, the PDM platform 12 may standardize the product data by converting numerical values to consistent measurement units (e.g., ounces to milliliters), normalizing character encoding formats (e.g., UTF-8), tokenizing and cleaning free-text fields for machine learning compatibility, harmonizing terminology to align with controlled vocabularies, and validating product attribute formats (e.g., ensuring numeric ranges for weights and dimensions). These operations prepare each product record to be uniform, syntactically correct, and machine-readable, ensuring that data from multiple sources can be accurately processed by the trained data model.

As shown by reference number 42, the PDM platform 12 may aggregate the standardized product data. Aggregation may include merging multiple product records for a single product, resolving field conflicts based on metadata, and consolidating product attributes from various data sources into a single, authoritative product record. This process may further include integrating curated contextual datasets, such as SEO keyword rankings, brand standards, regulatory rules, and category norms, into the record so that all guidance data is available to the machine learning inference pipeline. The result of aggregation is a unified, structured payload containing every data element needed for the data model to generate compliant and optimized product description information.

As shown in FIG. 2C, and by reference number 46, the PDM platform 12 may receive prompt description data from a user device 44 as part of a request to generate product description information for a product. In some embodiments, the request may include prompt data describing the request in a natural language. The prompt may be a general request for product description information for a product or may be a request to revise or update prompt data provided by a prompt engineer.

In the example shown, a prompt engineer may input a prompt stating: “Cheddar Cheese Dip is your simple solution to tasty snacking. Comprised of real cheddar cheese, milk, and a touch of Worcestershire sauce, the creamy dip is delightfully tangy. Perfect for birthdays, barbecues or just straight out of the jar, you can pair it with chips, veggies, or spread on your favorite sandwiches. Dive into the rich, cheese goodness of Cheddar Cheese Dip today!”

As shown by reference number 48, when the user submits the request, the prompt and any related metadata (e.g., a product identifier, etc.) is provided to the PDM platform 12.

In some embodiments, as shown by reference number 50, the PDM platform 12 may parse and process the request to identify a product identifier for the product and one or more user instructions included in the request. User instructions refers to any substantive product-specific material provided in the request and/or in the prompt.

As shown by reference number 52, the PDM platform 12 may retrieve product data for the product and one or more curated contextual datasets for the product. For example, the PDM platform 12 may use the product identifier to search a data structure hosted by data storage device 43 that associates a corresponding stored product identifier with the product data for the product. The PDM platform 12 may also retrieve the curated contextual datasets for the product. For example, if a particular regulatory law applies to the product, then contextual regulatory data identifying the applicable regulatory law may be provided as part of the curated contextual dataset.

As shown by reference number 56, the PDM platform 12 may use the data model to generate the product description information for the product. For example, the aggregated, standardized product data, user instructions, and curated contextual datasets may be provided as input to the data model. Internally, the data model may tokenize the input data into vector representations and align the data with corresponding constraint and/or rules vectors (e.g., regulatory flags, brand tone directives, SEO weightings, etc.). This input may be encoded as a combined embedding matrix representing both product facts and generation rules.

The data model may then process this input through a transformer-based architecture or other neural network, performing attention-weighting operations over product attributes and constraints. For example, allergen flags may receive strong attention weights in the output layer to ensure mandatory disclosures are not omitted, while SEO keyword embeddings may bias token selection probabilities in title generation. Brand tone vectors may adjust the activation values of descriptive adjectives to match stylistic guidelines. The model may output a fully structured label file, which may include a formatted product title, narrative description, bullet-point feature lists, ingredient statements, allergen disclosures, branding elements, and machine-readable codes (e.g., QR or UPC).

In some embodiments, even though the requested product description is for a new product, the PDM platform 12 will not need the prompt data from the prompt engineer because the data model has been trained to use predictive analytics to generate the product description. For example, assume the PDM platform 12 receives a request to generate a product description for a new brand of watch. The PDM platform 12 has already trained the data model to account for the industry norms for product descriptions of watches. Further, while the PDM platform 12 may not have access to the “brand voice” of the company who is selling the watch, the PDM platform 12 may predict the brand voice based on other available data. For example, if the price of the watch is relatively low compared to other market watches, then the PDM platform 12 may determine that the watch has a brand voice corresponding to a “value tier” (e.g., a tier encompassing more affordable products). In this way, the PDM platform 12 implements a predictive rules engine that predicts values of any data that may be unavailable. This conserves processing, networking, and/or memory resources relative to a platform that would always have to provide engineer-created prompts as an input to the system.

As shown by reference number 50, the PDM platform 12 may provide the product description information for display on the user device 44. For example, the PDM platform 12 may provide the product description for display on a user interface of the user device 44. In the example shown, the product description information states: “Cheddar Cheese Dip is a creamy, tangy snack made with real cheddar cheese, milk, and a hint of Worcestershire sauce. This versatile dip is perfect for parties, barbecues, or quick snacking straight from the jar. Pair it with chips, veggies, or spread it on your favorite sandwiches for a rich, cheesy flavor everyone will love.” In this example, the PDM platform 12 generates product description information in a manner that is more concise, compliant with regulations (e.g., made with real cheddar cheese, etc.), while avoiding unsubstantiated marketing claims. The tone is friendly but concise which aligns with branding norms for various food products.

In some embodiments, the PDM platform 12 may provide the product description information to a print system configured to generate a physical label for the product. In this way, the PDM platform 12 can be utilized to service product description information requests for both e-commerce and physical retail store scenarios.

By leveraging machine learning, the PDM platform efficiently and effectively generates detailed product descriptions, ensuring consistency, accuracy, and completeness across an array of different types of products. The PDM platform also enables the inclusion of detailed and standardized information such as ingredients, allergen warnings, nutritional facts, and other relevant details which are critical for consumer trust and decision-making. Further, the ability to update and maintain product descriptions ensures that the information remains current and relevant, further improving the consumer experience. Furthermore, PDM platform improves search engine visibility and consumer satisfaction in the products and drives sales growth and operational efficiency for retailers. Still further, the PDM platform significantly reduces the time and effort required to produce high-quality product descriptions for each product.

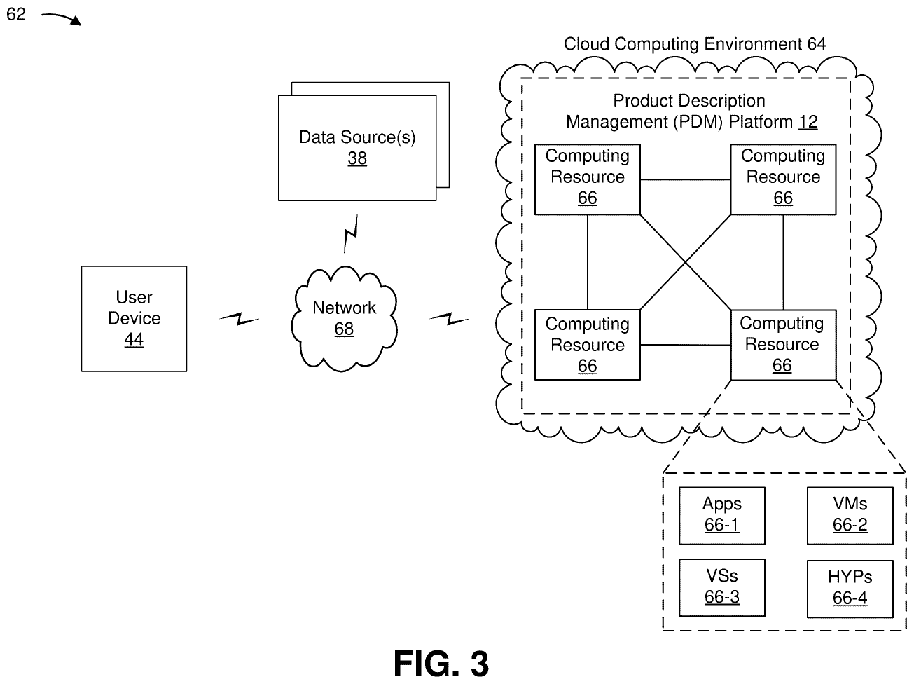

FIG. 3 is a diagram of an example environment 62 in which systems and/or methods described herein may be implemented. As shown in FIG. 3, environment 62 may include the user device 44, the one or more data sources 38, the PDM platform 12 supported within a cloud computing environment 64, and/or a network 68. Devices of environment 62 may interconnect via wired connections, wireless connections, or a combination of wired and wireless connections.

User device 44 includes one or more devices capable of receiving, generating, storing, processing, and/or providing information associated with product descriptions. For example, user device 44 may include a computing device, such as a tablet computer (e.g., an iPad, etc.), a mobile phone (e.g., a smart phone, a radiotelephone, etc.), a laptop computer, a handheld computer, a server computer, a gaming device, a wearable communication device (e.g., a smart wristwatch, a pair of smart eyeglasses, etc.), or a similar type of device. In some embodiments, the user device 44 may communicate with the PDM platform 12 using a communication interface, such as an API or another type of interface.

PDM platform 12 includes one or more devices capable of receiving, storing, processing, and/or providing information associated with product descriptions. For example, PDM platform 12 may include a computing device, a server device (e.g., a host server, a web server, an application server, etc.), a data center device, or a similar device. In some embodiments, the PDM platform 12 may have access to a database and/or data structure used to sort, organize, and filter one or more types of data described herein. In some embodiments, the database and/or data structure may be local to the PDM platform 12. In some embodiments, the database and/or data structure may be a third-party storage provider. In some embodiments, the PDM platform 12 may train a data model using machine learning. The data model may be used to make classifications, predictions, and/or recommendations in accordance with the principles of the present disclosure. In some embodiments, the data model may be trained by an external device or server and the trained data model may be provided to or made accessible to the PDM platform 12.

In some embodiments, as shown, the PDM platform 12 may be hosted in the cloud computing environment 64. Notably, while embodiments described herein describe the PDM platform 12 as being hosted in the cloud computing environment 64, in some embodiments, the PDM platform 12 may not be cloud-based (i.e., may be implemented outside of a cloud computing environment) or may be partially cloud-based.

Cloud computing environment 64 includes an environment that hosts PDM platform 12. Cloud computing environment 64 may provide computation, software, data access, storage, etc. services that do not require end-user knowledge of a physical location and configuration of system(s) and/or device(s) that hosts the PDM platform 12. As shown, the cloud computing environment 64 may include a group of computing resources 66 (referred to collectively as “computing resources 66” and individually as “computing resource 66”).

Computing resource 66 includes one or more personal computers, workstation computers, server devices, or another type of computation and/or communication device. In some embodiments, the computing resource 66 may host the PDM platform 12. The cloud resources may include compute instances executing in the computing resource 66, storage devices provided in the computing resource 66, data transfer devices provided by the computing resource 66, and/or the like. In some embodiments, the computing resource 66 may communicate with other computing resources 66 via wired connections, wireless connections, or a combination of wired and wireless connections.

As further shown in FIG. 3, computing resource 66 may include a group of cloud resources, such as one or more applications (“APPs”) 66-1, one or more virtual machines (“VMs”) 66-2, virtualized storage (“VSs”) 66-3, one or more hypervisors (“HYPs”) 66-4, and/or the like.

Application 66-1 may include one or more software applications that may be provided to or accessed by user device 44. Application 66-1 may eliminate a need to install and execute the software applications on these devices. In some embodiments, one application 66-1 may send/receive information to/from one or more other applications 235-1, via virtual machine 66-2. In some embodiments, application 66-1 may be a product description management application. In some embodiments, the product description management application may include one or more user interfaces that are accessible by users.

Virtual machine 66-2 may include a software implementation of a machine (e.g., a computer) that executes programs like a physical machine. Virtual machine 66-2 may be either a system virtual machine or a process virtual machine, depending upon use and degree of correspondence to any real machine by virtual machine 66-2. A system virtual machine may provide a complete system platform that supports execution of a complete operating system (“OS”). A process virtual machine may execute a single program and may support a single process. In some embodiments, virtual machine 66-2 may execute on behalf of another device (e.g., user device 44), and may manage infrastructure of the cloud computing environment 64, such as data management, synchronization, or long-duration data transfers.

Virtualized storage 66-3 may include one or more storage systems and/or one or more devices that use virtualization techniques within the storage systems or devices of the computing resource 66. In some embodiments, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 66-4 may provide hardware virtualization techniques that allow multiple operating systems (e.g., “guest operating systems”) to execute concurrently on a host computer, such as computing resource 66. Hypervisor 66-4 may present a virtual operating platform to the guest operating systems and may manage the execution of the guest operating systems.

Network 68 includes one or more wired and/or wireless networks. For example, network 68 may include a cellular network (e.g., a fifth generation (5G) network, a fourth generation (4G) network, such as a long-term evolution (LTE) network, a third generation (3G) network, a code division multiple access (CDMA) network, a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, or the like, and/or a combination of these or other types of networks.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of environment 62 may perform one or more functions described as being performed by another set of devices of environment 62.

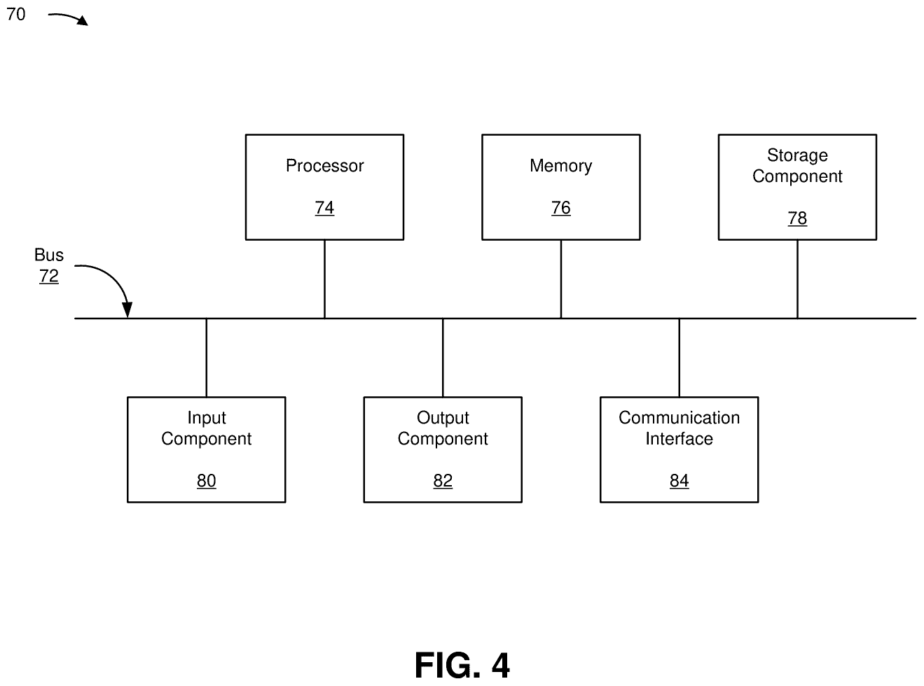

FIG. 4 is a diagram of example components of a device 70. Device 70 may correspond to the user device 44, the PDM platform 12, the one or more data sources 38, and/or any other device described herein. In some embodiments, the user device 44, the PDM platform 12, and/or the one or more data sources 38 may include one or more devices 70 and/or one or more components of device 70. As shown in FIG. 4, device 70 may include a bus 72, a processor 74, a memory 76, a storage component 78, an input component 80, an output component 82, and/or a communication interface 84.

Bus 72 includes a component that permits communication among multiple components of device 70. Processor 74 is implemented in hardware, firmware, and/or a combination of hardware and software. Processor 74 includes a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), and/or another type of processing component. In some embodiments, processor 74 includes one or more processors capable of being programmed to perform a function. Memory 76 includes a random-access memory (RAM), a read only memory (ROM), and/or another type of dynamic or static storage device (e.g., a flash memory, a magnetic memory, and/or an optical memory) that stores information and/or instructions for use by processor 74.

Storage component 78 stores information and/or software related to the operation and use of device 70. For example, storage component 78 may include a hard disk (e.g., a magnetic disk, an optical disk, a magneto-optic disk, and/or a solid-state disk), a compact disc (CD), a digital versatile disc (DVD), a floppy disk, a cartridge, a magnetic tape, and/or another type of non-transitory computer-readable medium, along with a corresponding drive.

Input component 80 includes a component that permits device 70 to receive information, such as via user input (e.g., a touch screen display, a keyboard, a keypad, a mouse, a button, a switch, and/or a microphone). Additionally, or alternatively, input component 80 may include a sensor for sensing information (e.g., a global positioning system (GPS) component, an accelerometer, a gyroscope, and/or an actuator). Output component 82 includes a component that provides output information from device 70 (e.g., a display, a speaker, and/or one or more light-emitting diodes (LEDs)).

Communication interface 84 includes a transceiver-like component (e.g., a transceiver and/or a separate receiver and transmitter) that enables device 70 to communicate with other devices, such as via a wired connection, a wireless connection, or a combination of wired and wireless connections. Communication interface 84 may permit device 70 to receive information from another device and/or provide information to another device. For example, communication interface 84 may include an Ethernet interface, an optical interface, a coaxial interface, an infrared interface, a radio frequency (RF) interface, a universal serial bus (USB) interface, a Wi-Fi interface, a cellular network interface, an application programming interface (API), and/or the like.

Device 70 may perform one or more processes described herein. Device 70 may perform these processes based on processor 74 executing software instructions stored by a non-transitory computer-readable medium, such as memory 76 and/or storage component 78. A computer-readable medium is defined herein as a non-transitory memory device. A memory device includes memory space within a single physical storage device or memory space spread across multiple physical storage devices.

Software instructions may be read into memory 76 and/or storage component 78 from another computer-readable medium or from another device via communication interface 84. When executed, software instructions stored in memory 76 and/or storage component 78 may cause processor 74 to perform one or more processes described herein. Additionally, or alternatively, hardwired circuitry may be used in place of or in combination with software instructions to perform one or more processes described herein. Thus, embodiments described herein are not limited to any specific combination of hardware circuitry and software.

The number and arrangement of components shown in FIG. 4 are provided as an example. In practice, device 70 may include additional components, fewer components, different components, or differently arranged components than those shown in FIG. 4. Additionally, or alternatively, a set of components (e.g., one or more components) of device 70 may perform one or more functions described as being performed by another set of components of device 70.

The foregoing disclosure provides illustration and description but is not intended to be exhaustive or to limit the embodiments to the precise form disclosed. Modifications and variations may be made in light of the above disclosure or may be acquired from practice of the embodiments.

Certain user interfaces have been described herein and/or shown in the figures. A user interface may include a graphical user interface, a non-graphical user interface, a text-based user interface, etc. A user interface may provide information for display. In some embodiments, a user may interact with the information, such as by providing input via an input component of a device that provides the user interface for display. In some embodiments, a user interface may be configurable by a device and/or a user (e.g., a user may change the size of the user interface, information provided via the user interface, a position of information provided via the user interface, etc.). Additionally, or alternatively, a user interface may be pre-configured to a standard configuration, a specific configuration based on a type of device on which the user interface is displayed, and/or a set of configurations based on capabilities and/or specifications associated with a device on which the user interface is displayed.

It will be apparent that systems and/or methods, described herein, may be implemented in different forms of hardware, firmware, and/or a combination of hardware and software. The actual specialized control hardware or software code used to implement these systems and/or methods is not limiting of the embodiments. Thus, the operation and behavior of the systems and/or methods were described herein without reference to specific software code—it being understood that software and hardware can be used to implement the systems and/or methods based on the description herein.

No element, act, or instruction used herein should be construed as critical or essential unless explicitly described as such. Also, as used herein, the articles “a” and “an” are intended to include one or more items and may be used interchangeably with “one or more.” Furthermore, as used herein, the term “set” is intended to include one or more items (e.g., related items, unrelated items, a combination of related and unrelated items, etc.), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. A method for generating product description information for a product, comprising:
receiving, by a computing device and as an input provided by a user, a request to generate the product description information for the product;
retrieving, by the computing device and by using a product identifier included in the request, product data for the product, the product data including a corresponding product identifier and data describing one or more attributes of the product;
determining, by the computing device, one or more user instructions indicated in the request;
retrieving, by the computing device, one or more contextual datasets curated with information relevant to the product, wherein the one or more contextual datasets include at least one of: search engine optimization (SEO) data, brand standards data, industry or organization norms data, and target consumer preferences data;
generating, by the computing device, the product description information for the product by providing the product data, the one or more user instructions, and the one or more contextual datasets as inputs to a data model to cause the data model to output the product description information for the product, wherein the data model is trained using machine learning to generate the product description information in a manner that complies with product description parameters derived from the one or more contextual datasets; and
providing, by the computing device, the product description information for display on a user interface of a device or application.

2. The method of claim 1, further comprising:
prior to receiving the request, obtaining heterogenous product data for the product from a plurality of disparate data sources;
standardizing the heterogenous product data by mapping product data values to a schema and normalizing the product data values into a uniform machine-readable format;
aggregating standardized product data to create the product data; and
storing the product data that has been standardized and aggregated in the data repository in a manner that is retrievable for use in generating the product description information.

3. The method of claim 1, further comprising:
retrieving another contextual dataset that includes regulatory rules data that identifies at least one law or regulation relating to the product description information; and
wherein generating the product description information comprises:
providing the regulatory rules data as an input to the data model such that the data model generates the product description information in a manner that is compliant with the at least one law or regulation.

4. The method of claim 1, further comprising:
providing, while the user in inputting a prompt as part of the request, feedback on compliance of the prompt with the product description parameters derived from at least one of the brand standards data, the SEO data, and the regulatory rules data, wherein the feedback is displayed on the user interface in a manner that emphasizes non-compliant words or phrases.

5. The method of claim 1, wherein the one or more contextual datasets include historical sales data and consumer preferences data, and wherein the data model is configured to apply weighted values to product description terms based on a frequency of consumer engagement with, or purchase of, the product.

6. The method of claim 1, wherein the product description information comprises: a narrative description of the product and a set of feature bullet points, each generated in a format optimized for a respective e-commerce platform or product listing channel.

7. The method of claim 1, further comprising:
providing the product description information to a print system configured to generate a physical label for the product.

8. A computing device for generating product description information for a product, comprising:
a memory storing instructions; and
a processor, communicatively coupled to the memory, and configured to:
receive, as an input provided by a user, a request to generate the product description information for the product;
retrieve product data for the product using a product identifier included in the request, the product data including a corresponding product identifier and data describing one or more attributes of the product;
determine one or more user instructions indicated in the request;
retrieve one or more contextual datasets curated with information relevant to the product, the one or more contextual datasets including one or more of: search engine optimization (SEO) data, brand standards data, industry or organization norms data, and target consumer preferences data;
generate the product description information for the product by providing the product data, the one or more user instructions, and the one or more contextual datasets as inputs to a data model to cause the data model to output the product description information for the product, wherein the data model is trained using machine learning to generate the product description information in a manner that complies with product description parameters derived from the one or more contextual datasets; and
provide the product description information for display on a user interface of a device or application.

9. The computing device of claim 8, wherein the one or more contextual datasets are periodically updated to reflect changes to the SEO criteria, brand standards, or industry or organization norms.

10. The computing device of claim 8, wherein the processor is further configured to:
retrieve another contextual dataset that includes regulatory rules data that identifies at least one law or regulation relating to the product description information; and wherein the processor, when generating the product description information, is configured to:
provide the regulatory rules data as an input to the data model such that the data model generates the product description information in a manner that is compliant with the at least one law or regulation.

11. The computing device of claim 8, wherein prior to receiving the request, the processor is configured to.
obtain heterogenous product data for the product from a plurality of disparate data sources;
standardize the heterogenous product data by mapping product data values to a schema and normalizing the product data values into a uniform machine-readable format;
aggregate standardized product data to create the product data; and
store the product data that has been standardized and aggregated in the data repository in a manner that is retrievable for use in generating the product description information.

12. The computing device of claim 8, wherein the processor is further configured to generate the product description information in a plurality of formats including a long-form description, a short-form summary, and an SEO-optimized title.

13. The computing device of claim 8, wherein the processor, when providing the product description information for display on the user interface, is configured to:
cause the user interface to display a split view showing a first section with the product description information prepared in a narrative description format and a second section with the product description information prepared in a bullet point format.

14. The computing device of claim 8, wherein the processor is further configured to provide, for display on the user interface, feedback of non-compliant text while the user is inputting a prompt as part of the request.

15. A non-transitory computer-readable medium storing instructions,
the instructions comprising one or more instructions that, when executed by a processor, cause the processor to:
receive, as an input provided by a user, a request to generate the product description information for the product;
retrieve product data for the product using a product identifier included in the request, the product data including a corresponding product identifier and data describing one or more attributes of the product;
determine one or more user instructions indicated in the request;
retrieve one or more contextual datasets curated with information relevant to the product, the one or more contextual datasets including one or more of: search engine optimization (SEO) data, brand standards data, industry or organization norms data, and target consumer preferences data;
generate the product description information for the product by providing the product data, the one or more user instructions, and the one or more contextual datasets as inputs to a data model to cause the data model to output the product description information for the product, wherein the data model is trained using machine learning to generate the product description information in a manner that complies with product description parameters derived from the one or more contextual datasets; and
provide the product description information for display on a user interface of a device or application.

16. The non-transitory computer-readable medium of claim 15, wherein the one or more instructions, that cause the processor to generate the product description information, further cause the processor to:
generate a set of feature bullet points by ranking product attributes according to a set of relevance scores derived from consumer engagement metrics.

17. The non-transitory computer-readable medium of claim 15, wherein the one or more instructions, that cause the processor to retrieve the one or more contextual datasets, further cause the processor to:
retrieve category-specific norms that define a preferred tone, attribute order, or feature emphasis for a respective product category.

18. The non-transitory computer-readable medium of claim 15, wherein the one or more instructions, when executed by the processor, further cause the processor to:
store the product description information that has been generated to a data structure in a format suitable for downstream editing or quality assurance review.

19. The non-transitory computer-readable medium of claim 15, wherein the one or more instructions, that cause the processor to provide the product description information for display, further cause the processor to:
provide visual feedback on the user interface in a manner that emphasizes a regulatory inconsistency or a brand guideline violation.

20. The non-transitory computer-readable medium of claim 15, wherein the one or more instructions, when executed by the processor, further cause the processor to:
retrieve another contextual dataset that includes regulatory rules data that identifies at least one law or regulation relating to the product description information; and
wherein the one or more instructions, that cause the processor to generate the product description information, further cause the processor to:
provide the regulatory rules data as an input to the data model such that the data model generates the product description information in a manner that is compliant with the at least one law or regulation.
